(19) United States
(12) Patent Application Publication
(10) Pub. No.: US 2015/0376034 A1
(43) Pub. Date: Dec. 31, 2015

(54) MULTI-STAGE REVERSE OSMOSIS MEMBRANE SYSTEM AND OPERATION METHOD THEREOF

(71) Applicant: KURITA WATER INDUSTRIES LTD., Tokyo (JP)

(72) Inventors: Kunihiro HAYAKAWA, Nakano-ku, Tokyo (JP); Takahiro KAWAKATSU, Nakano-ku, Tokyo (JP)

(21) Appl. No.: 14/766,334

(22) PCT Filed: Feb. 14, 2014
(86) PCT No.: PCT/JP2014/053472

§ 371 Date: Aug. 6, 2015

(30) Foreign Application Priority Data
Feb. 20, 2013 (JP) 2013-031033

(51) Int. Cl. C02F 1/44; B01D 61/02; B01D 63/10

(52) U.S. Cl. CPC C02F 1/441; B01D 63/103; B01D 61/022; B01D 2317/02

(57) ABSTRACT

A quality of treated water is improved without loss of stability in multi-stage reverse osmosis membrane treatment. Raw water in a raw water tank 1 is fed to a first-stage reverse osmosis membrane unit 3 by compression with a first pump 2, and concentrated water is discharged while permeated water is introduced into an intermediate tank 5 through a piping 4. The water in the intermediate tank 5 is fed to a second-stage reverse osmosis membrane unit 7 by compression with a second pump 6, and permeated water is taken out through a piping 8 while concentrated water is returned to the raw water tank 1 through a piping 9. The thickness of the raw water spacer of the reverse osmosis membrane units is more than 0.6 mm for the first stage and is 0.6 mm or less for the second stage.

### FIELD OF THE INVENTION

The present invention relates to a multi-stage reverse osmosis membrane system in which reverse osmosis membrane units are arranged in series in a multi-stage manner, and to an operation method thereof.

### BACKGROUND OF THE INVENTION

Reverse osmosis membrane units are widely used for removing ions, organic substances and the like from raw water in the fields of seawater desalination, ultrapure water production, industrial water treatment, and the like. When using reverse osmosis membrane units for water treatment, it is well known that a plurality of reverse osmosis membrane units are arranged in a multi-stage manner so that water treated in a preceding reverse osmosis membrane unit is further treated in another reverse osmosis membrane treatment unit in a subsequent stage, from the viewpoint of improving the quality of treated water (for example, Patent Literatures 1 and 4). In the case of seawater desalination, reverse osmosis membrane treatment is performed in two or more stages for removing boron. In the case of ultrapure water production, multi-stage treatment using reverse osmosis membranes is also generally performed (for example, Patent Literature 2).

A spiral membrane element is known as the reverse osmosis membrane element. A known spiral membrane element is formed by disposing a permeate spacer between two reverse osmosis membranes, bonding three sides of the membranes with adhesives to form an envelope-like membrane. An opening of the envelope-like membrane is attached to a permeate collecting tube and the envelope-like membrane is wound together with a mesh-like raw water spacer around the the permeate collecting tube in a spiral manner (Patent Literatures 3 and 4). The raw water spacer arranged between the envelope-like membranes forms a raw water channel. Raw water is fed to one end of the spiral membrane element and flows along the raw water spacer, and is consequently discharged as concentrated water from the other end of the spiral membrane element. While flowing along the raw water spacer, the water permeates the reverse osmosis membranes, thus being converted into permeate water. The permeate water flows along the permeate spacer in the envelope-like membrane and further into the permeate collecting tube, and is taken out from the end of the permeate collecting tube. According to the description in paragraph 0018 of Patent Literature 3, the preferred thickness of the raw water spacer is about 0.4 mm to 2 mm; according to the description in paragraph 0017 of Patent Literature 4, it is 0.4 mm to 3 mm.

In the case of using a reverse osmosis membrane unit for seawater desalination, ultrapure water production or industrial process water treatment, the clogging of the raw water channel with suspended matter is reduced by increasing the thickness of the raw water spacer of the reverse osmosis membrane device. Consequently, suspended matter are avoided to deposit and accumulate whereby the reverse osmosis membrane unit is prevented from an increase in the differential pressure for passing water and a decrease in the permeate flow rate and permeate quality, and the unit can be operated stably for a long period of time. However, increasing the thickness of the raw water spacer reduces the flow rate of raw water in the raw water channel. Consequently, ions and organic substances in water are concentrated excessively at the surface of the membrane (concentration polarization). This easily causes decrease in rejection due to concentration of solute, and decreasing in flux due to absorption of foulants to the membrane.

On the other hand, if the thickness of the raw water spacer is reduced, the flow rate increases. This makes an excessive concentration unlikely at the surface of the reverse osmosis membrane and improves the quality of treated water. In this instance, however, suspended matter in water to be treated is likely to clog the raw water channel (paragraph 0017 of Patent Literature 4), and thus there are some stability problems. Accordingly, the thickness of the spacers of commercially available reverse osmosis membranes is about 0.7 mm to 0.9 mm.

### LIST OF LITERATURE

### Patent Literature

Patent Literature 1: Japanese Patent Publication 2010-125395 A

Patent Literature 2: Japanese Patent Publication 2002-1069 A

Patent Literature 3: Japanese Patent Publication 11-57429 A

Patent Literature 4: Japanese Patent Publication 2004-89761 A

### OBJECT OF THE INVENTION

It is an object of the present invention to improve the quality of treated water without loss of stability in multi-stage reverse osmosis membrane treatment used for seawater desalination, ultrapure water production, or the like.

### SUMMARY OF THE INVENTION

The multi-stage reverse osmosis membrane system of the present invention comprises: reverse osmosis membrane units arranged in a multi-stage manner so that water treated in a preceding reverse osmosis membrane unit is treated in another reverse osmosis membrane unit in a subsequent stage, the reverse osmosis membrane units each including a spiral membrane element formed by winding an envelope-like reverse osmosis membrane together with a raw water spacer,wherein the raw water spacer of the membrane element of the first-stage reverse osmosis membrane unit has a thickness of more than 0.6 mm, and the raw water spacer of the membrane element of the second-stage or higher-stage reverse osmosis membrane unit has a thickness of 0.6 mm or less.

In the method for operating the multi-stage reverse osmosis membrane system of the present invention, the first-stage reverse osmosis membrane unit has a permeation flux of 1.0 m/d or less, and the second-stage or higher-stage reverse osmosis membrane unit has a permeation flux of 1.1 m/d or more.

### Advantageous Effects of Invention

In the multi-stage reverse osmosis membrane system of the present invention, the first-stage reverse osmosis membrane unit includes the raw water spacer having a large thickness, so that suspended matter does not easily clog the raw water flow channel. Consequently, stable operation can be ensured over a long time while suspended matter is prevented from depositing, the pressure loss of passing water is prevented from increasing, the permeate flow rate and permeate quality are prevented from decreasing. The raw water spacer of the second-stage or higher stage reverse osmosis membrane unit has a small thickness, so that the flow rate in the raw water channel is increased. Consequently, an excessive concentration becomes unlikely to occur at the surface of the reverse osmosis membrane, and the quality of treated water is improved. Since suspended matter has been removed by the first-stage reverse osmosis membrane unit, the water to be passed through the second-stage or higher-stage reverse osmosis membrane for treatment does not contain suspended matter. Accordingly, there is no risk of clogging the second-stage or higher-stage reverse osmosis membrane unit.

By reducing the thickness of the raw water spacer of the second-stage or higher-stage reverse osmosis membrane unit, the membrane area per element is increased. This increases permeation flux, and reduces the number of membrane elements in the second and higher stages as well as costs.

The present inventors found that the real rejection of a reverse osmosis membrane depends on the permeation flux. In the method of the present invention, the rejection of membranes can be increased by making the permeation flux in operation in the second and higher stages larger than the permeation flux in the first stage.

### BRIEF DESCRIPTION OF DRAWINGS

FIG. 1 is a system diagram of a multi-stage reverse osmosis membrane system according to an embodiment.

FIG. 2 is a plot showing the relationship between the flow rate of brine (concentrated water) and the concentration rate for raw water spacers having different thicknesses.

FIG. 3 is a plot showing the relationship between permeation flux and real rejection.

FIG. 4 is a sectional view of a flat membrane cell for examination.

### DESCRIPTION OF EMBODIMENTS

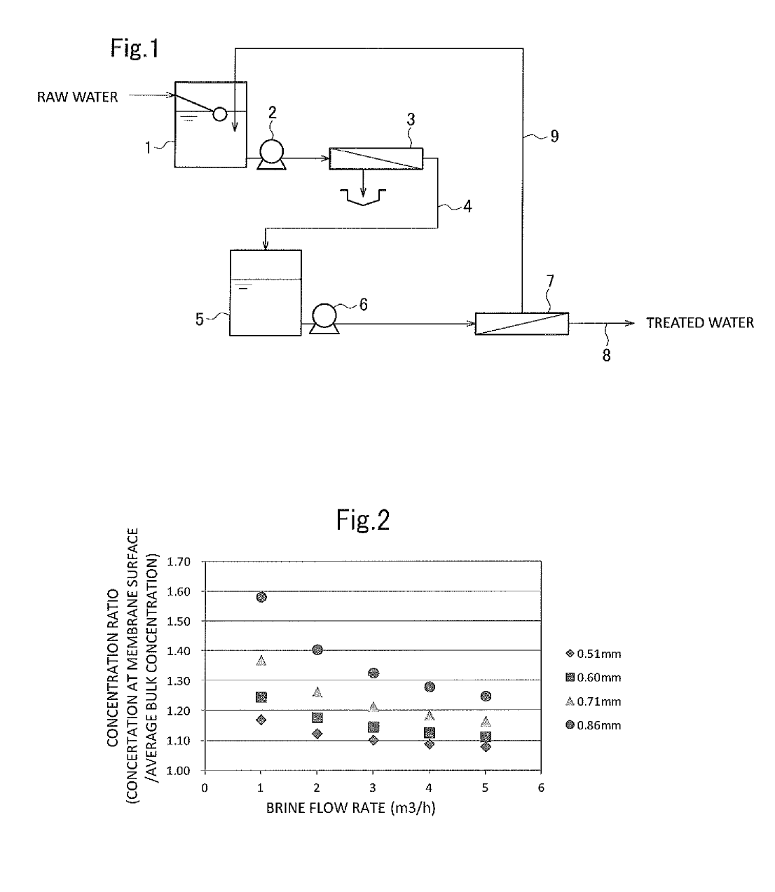

A multi-stage reverse osmosis membrane system according to an embodiment of the present invention will now be described with reference to FIG. 1. In the multi-stage reverse osmosis membrane system, raw water in a raw water tank 1 is fed to a first-stage reverse osmosis membrane unit 3 by compression with a first pump 2, and concentrated water is discharged while permeated water is introduced into an intermediate tank 5 through a piping 4. The water in the intermediate tank 5 is fed to a second-stage reverse osmosis membrane unit 7 by compression with a second pump 6, and permeated water is taken out through a piping 8 while concentrated water is returned to the raw water tank 1 through a piping 9.

The first-stage and second-stage reverse osmosis membrane units 3 and 6 each include a spiral membrane element. The spiral membrane element has a structure in which an envelope-like membrane containing a permeate spacer therein is superposed on a raw water spacer, and the envelope-like membrane and the raw water spacer are wound around a permeate-collecting tube. Alternatively, a spiral membrane element may be formed by winding an envelope-like membrane having a permeate outlet at a part of the side thereof and containing a permeate spacer therein around a shaft instead of the permeate-collecting tube together with a raw water spacer as shown in FIG. 2 of the above-cited Patent Literature 3. The present invention is not limited to a spiral type, and a flat membrane element may be used. The thickness of the raw water spacer of the reverse osmosis membrane units is more than 0.6 mm for the first stage and is 0.6 mm or less for the second stage.

Although the reverse osmosis membrane units are arranged in a two-stage manner in the system shown in FIG. 1, an arrangement in three or more stages may be applied. The thickness of the raw water spacer of the third-stage or higher-stage reverse osmosis membrane unit is 0.6 mm or less.

Any reverse osmosis membrane may be used, including those for seawater desalination, low pressure, ultra-low pressure, and ultra-super low pressure. The material of the reverse osmosis membrane may be, but is not limited to, cellulose acetate or polyamide, and can be selected according to the required rejection and flux. When a membrane element having a high rejection is used, it is preferable to use a reverse osmosis membrane of aromatic polyamide synthesized from phenylenediamine and an acid chloride.

The raw water spacer may be a mesh spacer which is formed by arranging a plurality of synthetic resin wire rods of, for example, polyethylene or polypropylene having the same or different diameters (wire diameter) at regular intervals and stacking those so as to intersect at an angle of 45 degrees to 90 degrees. The raw water spacer preferably has a porosity in the range of 60% to 95%. Such a raw water spacer can produce a stirring effect sufficiently high to suppress concentration polarization.

Preferably, the mesh size of the raw water spacer is in the range of 1 mm to 4 mm. Such a raw water spacer produces a sufficiently high stirring effect and suppresses concentration polarization, whereby suppressing an increase in flow resistance of raw water and exhibiting high separation performance. The raw water spacer is not limited to a mesh spacer. For example, the raw water spacer may be formed of zigzag wire rods as shown in FIG. 6 in the above-cited Patent Literature 4.

The raw water spacer of the first-stage reverse osmosis membrane unit has a thickness more than 0.6 mm, preferably 0.7 mm or more from the viewpoint of preventing clogging with suspended matter. An excessively large thickness of the raw water spacer increases concentration polarization and reduces rejection. Accordingly, the thickness is preferably 2.0 mm or less.

The raw water spacer of the second or higher stage reverse osmosis membrane unit has a thickness of 0.6 mm or less. FIG. 2 shows the degrees of NaCl concentration polarization in spiral reverse osmosis membrane modules of 8 inches in diameter including raw water spacers having different thicknesses. As shown in FIG. 2, when the spacer has a thickness of 0.6 mm or more, an influence of concentration polarization becomes large, and the ratio of the concentration at the membrane surface to the average bulk concentration exceeds undesirably 1.2 times in the region where a concentrated water flow rate is 2 m³/h or more. The raw water spacer having a thickness of 0.6 mm or less can prevent concentration polarization and enables the production of high-quality treated water. When the thickness of the raw water spacer is less than 0.2 mm, however, the water passing resistance thereof increases excessively. Accordingly, the thickness is preferably 0.2 mm or more. Thus, the thickness of the raw water spacer of the second-stage reverse osmosis membrane unit is preferably 0.2 mm to 0.6 mm, more preferably 0.2 mm to 0.5 mm, and further more preferably 0.3 mm to 0.5 mm.

The permeate spacer to be disposed in the envelope-like membrane preferably has a thickness of, but not limited to, 0.1 mm to 0.25 mm. The permeate spacer having an excessively large thickness has a small membrane area per element, as in the case of the raw water spacer; the permeate spacer having an excessively small thickness increases pressure differential and reduces permeate flow rate.

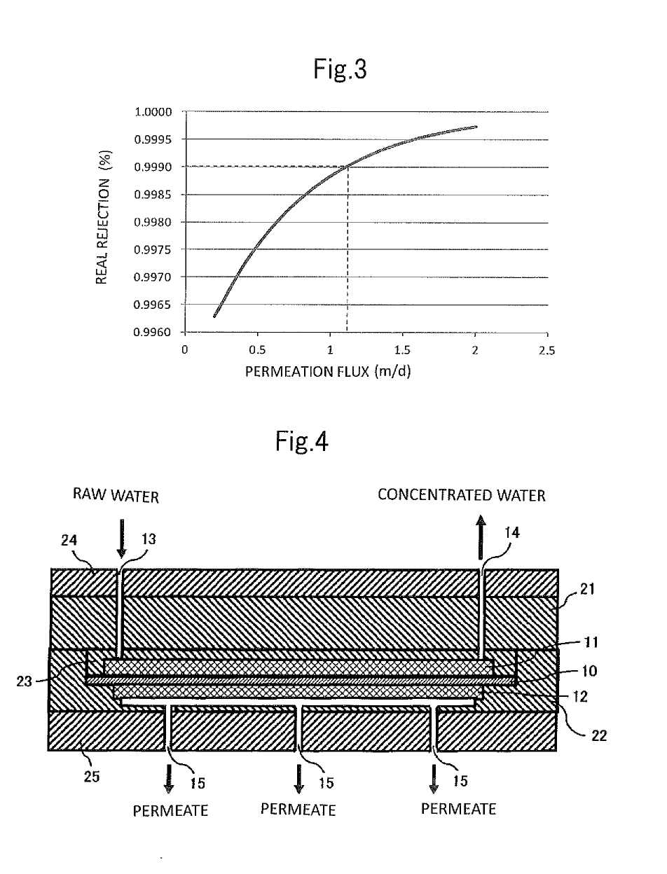

As shown in FIG. 3, the real NaCl rejection depends on permeation flux. As the permeation flux is increased, the real rejection increases. The permeation flux of the second-stage reverse osmosis membrane unit is preferably 1.1 m/d to 2.0 m/d. When it is 1.1 m/d or more, the real rejection exceeds 99.9%. This is advantageous for improving water quality. An excessively low permeation flux leads to a reduced real rejection and results in degraded water quality. A permeation flux of 2.0 m/d or more is undesirable in view of the pressure resistance of the membrane and due to the increase of water passing resistance. Although the real rejection varies depending on the substance to be removed, the real rejection for any substance depends on the permeation flux. Hence, by increasing the real rejection for NaCl, the rejection rate for other substances can be increased.

The permeation flux of the first-stage reverse osmosis membrane unit is preferably 0.2 m/d to 1.0 m/d, and more preferably 0.6 m/d to 0.8 m/d. When the permeation flux is 1.0 m/d or more, membrane fouling and clogging rates increase, and accordingly, washing frequency is increased. This is not economically efficient, since the system must be stopped every time when it is washed. When the permeation flux is less than 0.2 m/d, the number of membranes is increased. This is not economically efficient.

### EXAMPLES

Examples and Comparative Examples will now be described below. The following Examples and Comparative Examples employed a multi-stage reverse osmosis membrane system having the flow shown in FIG. 1. A flat membrane test cell shown in FIG. 4 was employed as reverse osmosis membrane units 3 and 7.

The flat cell shown in FIG. 4 has a structure in which a membrane unit that is a stack of a raw water spacer 11 and a permeate spacer 12 with a reverse osmosis membrane 10 therebetween is held in a space formed by combining acrylic flow channel-defining members 21, 22, and 23 and SUS pressure-resistant reinforcing members 24 and 25.

Raw water is fed to a first side of the reverse osmosis membrane 10 through a raw water inlet 13 and flows along the raw water spacer 11. In the course of this flow, permeated water that has permeated the reverse osmosis membrane 10 is taken out through the permeate spacer 12 from permeate outlets 15. Concentrated water is taken out from a concentrated water outlet 14.

### Example 1

Industrial water subjected to flocculation-aggregation and filtration (TOC concentration: 500 ppb (0.5 mg/L)) was used as raw water. The raw water was introduced to the multi-stage reverse osmosis membrane system having the flow shown in FIG. 1.

The inventors assumed the use of a commercially available 8-inch spiral reverse osmosis membrane element as the reverse osmosis membrane of the first-stage reverse osmosis membrane unit 3. A piece of flat membrane of 50 mm in width×800 mm in length was cut out from a reverse osmosis membrane ES20 manufactured by Nitto Denko Corporation, and the piece was installed in a SUS water passing cell together with a 0.71 mm thick polypropylene raw water spacer (wire diameter: 0.25 to 0.36 mm, openings: 2.6 mm), as shown in FIG. 4.

The inventors assumed also the use of the same reverse osmosis membrane element as the reverse osmosis membrane of the second-stage reverse osmosis membrane unit 7. A piece of flat membrane of 50 mm in width×800 mm in length was cut out from the same reverse osmosis membrane ES20 manufactured by Nitto Denko Corporation, and the piece was installed in a SUS water passing cell together with a 0.60 mm thick polypropylene raw water spacer (wire diameter: 0.2 mm to 0.3 mm, openings: 2.2 mm), as shown in FIG. 4.

Provided that the above first-stage and second-stage membrane elements are each installed in an 8-inch reverse osmosis membrane unit, membrane areas are 41.8 m² and 46.0 m², respectively.

The raw water was fed to the first-stage reverse osmosis membrane unit such that the permeation flux was 0.6 m/d, and concentrated water flew at 3.6 m³/h in terms of the 8-inch element. Water was fed to the second-stage reverse osmosis membrane unit such that the permeation flux was 1.0 m/d, and concentrated water flew at 3.6 m³/h in terms of an 8-inch element. Table 1 shows the TOC concentration of the second-stage treated water (permeated water from the second-stage reverse osmosis membrane unit) after passing water for 500 hours, the calculated permeate flow rate (converted into a permeate flow rate at 0.75 MPa) and the pressure differential of the first-stage element.

### Example 2

An experiment was conducted under the same conditions as in Example 1, except that the second-stage reverse osmosis membrane was set to a permeation flux of 1.1 m/d. Table 1 shows the TOC concentration of treated water after passing water for 500 hours, the calculated permeate flow rate (converted into a permeate flow rate at 0.75 MPa) and the pressure differential of the first-stage element.

### Example 3

An experiment was conducted under the same conditions as in Example 1, except that the raw water spacer of the second-stage reverse osmosis membrane had a wire diameter of 0.15 mm to 0.25 mm, openings of 2.0 mm and a thickness of 0.5 mm. If this membrane element is installed in an 8-inch reverse osmosis membrane unit, the membrane area is 50.2 m². Table 1 shows the TOC concentration of treated water after passing water for 500 hours, the calculated permeate flow rate (converted into a permeate flow rate at 0.75 MPa) and the pressure differential of the first-stage element.

### Example 4

An experiment was conducted under the same conditions as in Example 3, except that the second-stage reverse osmosis membrane unit was set to a permeation flux of 1.1 m/d. Table 1 shows the TOC concentration of treated water after passing water for 500 hours, the calculated permeate flow rate (converted into a permeate flow rate at 0.75 MPa), and the pressure differential of the first-stage element.

### Example 5

An experiment was conducted under the same conditions as in Example 3, except that the second-stage reverse osmosis membrane was set to a permeation flux of 1.3 m/d. Table 1 shows the TOC concentration of treated water after passing water for 500 hours, the calculated permeate flow rate (converted into a permeate flow rate at 0.75 MPa) and the pressure differential of the first-stage element.

### Example 6

An experiment was conducted under the same conditions as in Example 1, except that the first-stage reverse osmosis membrane was set to a permeation flux of 1.1 m/d. Table 1 shows the TOC concentration of treated water after passing water for 500 hours, the calculated permeate flow rate (converted into a permeate flow rate at 0.75 MPa) and the pressure differential of the first-stage element.

### Comparative Example 1

An experiment was conducted under the same conditions as in Example 1, except that the raw water spacer of the second-stage reverse osmosis membrane had a wire diameter of 0.25 mm to 0.36 mm, openings of 2.6 mm and a thickness of 0.71 mm. If this membrane element is installed in an 8-inch reverse osmosis membrane unit, the membrane area is 41.8 m². Measurements were performed for the TOC concentration after passing water for 500 hours, the calculated permeate flow rate (converted into a permeate flow rate at 0.75 MPa), and the pressure differential of the first-stage element. The results are shown in Table 1.

### Comparative Example 2

An experiment was conducted under the same conditions as in Example 1, except that the raw water spacer of the first-stage reverse osmosis membrane had a wire diameter of 0.2 mm to 0.3 mm, openings of 2.2 mm, and a thickness of 0.6 mm. If this membrane element is installed in an 8-inch reverse osmosis membrane unit, the membrane area is 46.0 m². Measurements were performed for the TOC concentration after passing water for 500 hours, the calculated permeate flow rate (converted into a permeate flow rate at 0.75 MPa), and the pressure differential of the first-stage element. The results are shown in Table 1.

TABLE 1

| | First-stage reverse | | | | Second-stage reverse | | | | | | |
|---|---|---|---|---|---|---|---|---|---|---|---|
| | osmosis membrane unit | | | | osmosis membrane unit | | | | Second-stage | | First-stage |
| | Raw water | | | | Raw water | | | | treated water | First-stage | element |
| | spacer | Membrane | | Permeate | spacer | Membrane | | Permeate | TOC | permeation flux | pressure |
| | thickness | area | Flux | flow rate | thickness | area | Flux | flow rate | concentration | converted (m/d | differential |
| | (mm) | (m²) | (m/d) | (m³/d) | (mm) | (m²) | (m/d) | (m³/d) | (ppb) | at 0.75 MPa) | (MPa) |
| Example 1 | 0.71 | 41.8 | 0.6 | 25.1 | 0.6 | 46 | 1 | 46.0 | 20 | 0.7 | 0.05 |
| Example 2 | 0.71 | 41.8 | 0.6 | 25.1 | 0.6 | 46 | 1.1 | 50.6 | 15 | 0.7 | 0.05 |
| Example 3 | 0.71 | 41.8 | 0.6 | 25.1 | 0.5 | 50.2 | 1 | 50.2 | 18 | 0.7 | 0.05 |
| Example 4 | 0.71 | 41.8 | 0.6 | 25.1 | 0.5 | 50.2 | 1.1 | 55.2 | 14 | 0.7 | 0.05 |
| Example 5 | 0.71 | 41.8 | 0.6 | 25.1 | 0.5 | 50.2 | 1.3 | 65.3 | 10 | 0.7 | 0.05 |
| Example 6 | 0.71 | 41.8 | 1.1 | 46.0 | 0.6 | 46 | 1 | 46.0 | 12 | 0.5 | 0.05 |
| Comparative | 0.71 | 41.8 | 0.6 | 25.1 | 0.71 | 41.8 | 1 | 41.8 | 23 | 0.7 | 0.05 |
| Example 1 | | | | | | | | | | | |
| Comparative | 0.6 | 46 | 0.6 | 27.6 | 0.6 | 46 | 1 | 46.0 | 18 | 0.7 | 0.15 |
| Example 2 | | | | | | | | | | | |

As shown in Table 1, Examples 1 to 6 produced highly pure treated water with a low TOC concentration. In Example 6, the permeation flux was reduced after passing water for 500 hours because the first stage had a higher permeation flux than that in the other Examples. Comparative Example 1 was a conventional treatment method. In Comparative Example 2, the treated water was better in terms of water quality, but the pressure differential of the first-stage reverse osmosis membrane was increased early due to the reduced thickness thereof. Thus, stability was deteriorated.

### Example 7

The inventors assumed the use of a commercially available 8-inch spiral reverse osmosis membrane element as the reverse osmosis membrane of the first-stage reverse osmosis membrane unit 3. A piece of flat membrane of 50 mm in width×800 mm in length was cut out from a reverse osmosis membrane ES20 manufactured by Nitto Denko Corporation, and the piece was installed in a SUS water passing cell together with a 0.86 mm thick polypropylene raw water spacer (wire diameter: 0.3 to 0.43 mm, openings: 3.0 mm), as shown in FIG. 4.

A piece of flat membrane of 50 mm in width×800 mm in length was cut out, as the reverse osmosis membrane of the second-stage reverse osmosis membrane unit 7, from a reverse osmosis membrane ES20 manufactured by Nitto Denko Corporation, and the piece was installed in a SUS water passing cell together with a 0.60 mm thick polypropylene raw water spacer (wire diameter: 0.2 to 0.3 mm, openings: 2.2 mm), as shown in FIG. 4.

If the first-stage and second-stage membrane elements are each installed in an 8-inch reverse osmosis membrane unit, membrane areas are 37.1 m² and 46.0 m², respectively.

Biologically treated water subjected to flocculation-aggregation and filtration (TOC concentration: 1100 ppb (1.1 mg/L)) was used as raw water. The raw water was fed to the first-stage reverse osmosis membrane unit such that a permeation flux was 0.6 m/d, and concentrated water flew at 3.6 m³/h in terms of the 8-inch element. Water was fed to the second-stage reverse osmosis membrane unit such that a permeation flux was 1.0 m/d, and concentrated water flew at 3.6 m³/h in terms of an 8-inch element. Table 2 shows the TOC concentration of treated water after passing water for 500 hours, the calculated permeate flow rate (converted into a permeate flow rate at 0.75 MPa), and the pressure differential of the first-stage element.

### Comparative Example 3

An experiment was conducted under the same conditions as in Example 7, except that the raw water spacer of the second-stage reverse osmosis membrane had a wire diameter of 0.25 mm to 0.36 mm, openings of 2.6 mm, and a thickness of 0.71 mm. If this membrane element is installed in an 8-inch reverse osmosis membrane unit, the membrane area is 41.8 m². Table 2 shows the TOC concentration of treated water after passing water for 500 hours, the calculated permeate flow rate (converted into a permeate flow rate at 0.75 MPa) and the pressure differential of the first-stage element.

### Comparative Example 4

An experiment was conducted under the same conditions as in Example 3, except that the raw water spacer of the first-stage reverse osmosis membrane had a wire diameter of 0.25 mm to 0.36 mm, openings of 2.6 mm, and a thickness of 0.71 mm. If this membrane element is installed in an 8-inch reverse osmosis membrane unit, the membrane area is 41.8 m². Table 2 shows the TOC concentration of treated water after passing water for 500 hours, the calculated permeate flow rate (converted into a permeate flow rate at 0.75 MPa) and the pressure differential of the first-stage element.

TABLE 2

| | First-stage reverse | | | | Second-stage reverse | | | | | | |
|---|---|---|---|---|---|---|---|---|---|---|---|
| | osmosis membrane unit | | | | osmosis membrane unit | | | | Second-stage | | First-stage |
| | Raw water | | | | Raw water | | | | treated water | First-stage | element |
| | spacer | Membrane | | Permeate | spacer | Membrane | | Permeate | TOC | permeation flux | pressure |
| | thickness | area | Flux | flow rate | thickness | area | Flux | flow rate | concentration | converted (m/d | differential |
| | (mm) | (m²) | (m/d) | (m³/d) | (mm) | (m²) | (m/d) | (m³/d) | (ppb) | at 0.75 MPa) | (MPa) |
| Example 7 | 0.86 | 37.1 | 0.6 | 22.3 | 0.6 | 46 | 1 | 46.0 | 38 | 0.6 | 0.05 |
| Comparative | 0.86 | 37.1 | 0.6 | 22.3 | 0.71 | 41.8 | 1 | 41.8 | 43 | 0.6 | 0.05 |
| Example 3 | | | | | | | | | | | |
| Comparative | 0.71 | 41.8 | 0.6 | 25.1 | 0.71 | 41.8 | 1 | 41.8 | 41 | 0.6 | 0.15 |
| Example 4 | | | | | | | | | | | |

As shown in Table 2, Example 7 produced more high-quality treated water and exhibited a higher permeate flow rate than Comparative Example 3. In Comparative Example 4, the pressure differential of the first-stage element was increased, and thus stability was deteriorated.

As is clear from the Examples and Comparative Examples, the multi-stage reverse osmosis membrane system of the present invention can produce treated water having higher purity than the multi-stage reverse osmosis membrane systems using raw water spacers having the same thickness in the first-stage and second-stage reverse osmosis membrane units, and thus can improve water quality without loss of stability.

While the present invention has been described with reference to specific embodiments, it is to be understood by those skilled in the art that various modifications may be made without departing from the intention and scope of the invention.

The present application is based on Japanese Patent application No. 2013-031033 filed on Feb. 20, 2013, the entirety of which is incorporated herein by reference.

1. A multi-stage reverse osmosis membrane system comprising: reverse osmosis membrane units arranged in a multi-stage manner so that water treated in a preceding reverse osmosis membrane unit is treated in another reverse osmosis membrane unit in a subsequent stage, the reverse osmosis membrane units each including a spiral membrane element formed by winding an envelope-like reverse osmosis membrane together with a raw water spacer,
wherein the raw water spacer of the membrane element of the first-stage reverse osmosis membrane unit has a thickness of more than 0.6 mm, and the raw water spacer of the membrane element of the second-stage or higher-stage reverse osmosis membrane unit has a thickness of 0.6 mm or less.

2. The multi-stage reverse osmosis membrane system according to claim 1, wherein the thickness of the raw water spacer of the first-stage reverse osmosis membrane unit is 0.7 mm to 2 mm, and the thickness of the raw water spacer of the second-stage or higher-stage reverse osmosis membrane unit is 0.2 mm to 0.6 mm.

3. A method for operating the multi-stage reverse osmosis membrane system according to claim 1, wherein the first-stage reverse osmosis membrane unit has a permeation flux of 1.0 m/d or less, and the second-stage or higher-stage reverse osmosis membrane unit has a permeation flux of 1.1 m/d or more.
